(19) United States
(12) Patent Application Publication
(10) Pub. No.: US 2005/0273342 A1
(43) Pub. Date: Dec. 8, 2005

(54) Centralized digital paper distribution across an industry

(76) Inventors: Menachem Levy, Brooklyn, NY (US); Yishai Hornbacher, Brooklyn, NY (US); Shayna Leah Hershfeld, Brooklyn, NY (US)

Correspondence Address: OPPEDAHL AND LARSON LLP, P O BOX 5068, DILLON, CO, 80435-5068, US

(21) Appl. No.: 10/536,331

(22) PCT Filed: Mar. 18, 2004
(86) PCT No.: PCT/US04/08226

§ 371 Date: May 25, 2005

Related U.S. Application Data
(60) Provisional application No. 60/455,415, filed on Mar. 18, 2003.
(60) Provisional application No. 60/489,912, filed on Jul. 25, 2003.

(51) Int. Cl. G06F 17/60

(52) U.S. Cl. 705/1

(57) ABSTRACT

A first entity, receives from customer or form an agency on behalf of a customer an ingredient list comprising ingredients and contact information for a supplier of each ingredient. For each ingredient needing a certificate, the first entity contacts each respective supplier requesting a copy of a kosher letter for the ingredient. The kosher letter is received and one or more associated unique identifiers are assigned and communicated to the supplier and/or any other subscribed party such as the customer(s) and/or the agency or agencies certifying the manufactured product made with this ingredient list, as applicable. This eliminates the need for the supplier and/or the customer to have to take further action with respect to the kosher letters. A kosher certification agency is able to use the unique identifiers to obtain information for use in deciding whether to grant a kosher certification to the product of the ingredient list. The first entity notes when kosher letters are going to expire and requests new kosher letters directly from the associated suppliers, eliminating the need for the customer or agency to perform that action.

This application claims priority from U.S. appl. No. 60/455,415 filed Mar. 18, 2003, and U.S. appl. No. 60/489,912 filed Jul. 25, 2003, both of which are incorporated herein by reference for all purposes.

### BACKGROUND

The invention relates generally to storing. and retrieving information relating to qualities of food products and ingredients, and relates more particularly to systems and methods to do this more efficiently and inexpensively.

As will be described herein, it is not easy to set up systems permitting sellers of food products to be able to provide information about the kosher status of foods to consumers. It is helpful to provide some background about known ways to try to provide such information. Additional helpful background may be found in PCT publication WO 02/080074, published Oct. 10, 2002, incorporated herein by reference for all purposes.

“You shall not seethe a calf in its mother's milk.” This statement in the Torah is one of several which represent the historical origins of definitions permitting an observant Jew to determine whether a food is kosher. An observant Jew will thus avoid mixing meat and milk in a meal, and will likewise avoid any food product in which meat and milk have been mixed. In a meal containing meat (a “meat meal”) it is necessary to avoid products containing milk. In a meal containing milk (a “milk meal”) it is necessary to avoid products containing meat It will be appreciated that for manufactured products, labeling is extremely important. A consumer considering purchasing a product containing milk ingredients will want to know, with extremely high confidence, that the product does not contain meat ingredients, and vice versa. The consumer considering purchasing goods to be consumed during Passover will want to know, with similarly high confidence, that the product is free from leaven. It is particularly convenient to know which products are free from both milk and meat ingredients, since such products (called “pareve”) may be freely included in a meat meal or a milk meal. The Torah also defines certain things (e.g. beef that has not been properly slaughtered and treated) which are not to be eaten at all.

Determining whether a product is kosher thus requires paying extremely close attention to the ingredients of which the product is made. In addition, it will be appreciated that there are several kosher qualities that are of interest, such as whether a product is pareve, or kosher for Passover, or “kosher dairy” (meaning that it is kosher but may not be mixed with meat). This, too, requires paying close attention to the ingredients of which the product is made. But these determinations also require paying close attention to the other ingredients used elsewhere in a manufacturing facility, for example for the manufacture of other products. Close attention must also be paid to the manner in which ingredients and finished products are packaged and transported.

In a simpler world, a consumer might personally have knowledge permitting the consumer to have high confidence in a seller's description of a product, perhaps being personally acquainted with the maker of the product and with the makers of the ingredients that went into the product In today's globalized world, makers of products are distant from the purchasers of the products, and are also distant from the makers of the ingredients used to make the products. It is unrealistic for any single consumer to expect to be able to have personal knowledge permitting a high confidence as to the kosher qualities of products to be purchased.

Fortunately for the consumer who wishes to know the kosher status of particular products to be purchased, there are certification agencies which do the work of paying close attention to ingredient lists and ingredients and the many other things that permit a consumer to have a high level of confidence as to the kosher status. The certification agencies certify the status of particular products, and they permit the use of markings which consumers can recognize and use in making their product selections.

Let us suppose that a food manufacturer decides that it wants to sell and market a product as kosher. Such a decision is typically motivated by customer demand. For example, the manufacturer may have done market research which suggests that a product can be better marked if it is kosher. In practical terms a consumer who wishes to be confident that a product marked as kosher really is kosher will look for a marking indicating that a certification agency has certified the kosher status of the product.

Potential customers may well differ from one to the next in the kosher requirements they impose upon their product purchasing choices. As a related matter, certification agencies may differ from each other in the requirements they impose to certify a particular type of product as kosher. One potential customer may choose only to purchase products certified by a particular certification agency, while another may be willing to purchase products certified by any of several certification agencies.

A manufacturer of a kosher product necessarily needs to use kosher ingredients. A manufacturer of an ingredient who wishes to be able to sell the ingredient to a manufacturer of a kosher product will need to be able to provide assurance to its customer that the ingredient is kosher.

Many manufacturers have relationships with particular certification agencies. But a first step for a manufacturer that has not previously had products certified as kosher will be to contact a certification agency. A manufacturer whose interest is in selling ingredients to a customer manufacturer (who sell kosher products) may become acquainted with a certification agency because it certifies the customer's products. A manufacturer of consumer products that is interested in obtaining kosher certification for its products may become acquainted with a certification agency because it certifies the kosher status of one of the manufacturer's ingredients.

A certification agency will typically only certify products after a physical inspection of the manufacturing facility or facilities involved. The agency must necessarily keep track of certain information about the manufacturer, and must inspect the facilities at regular intervals to ascertain that the information is correct. Such information includes the product to be certified, the ingredients used to make the product, and the production methods used. In addition, it is necessary to know what other products and ingredients are used on the same equipment, and which facilities are used to make the products. It will be appreciated that this means keeping track of which ingredients are used in which product and the process of producing each product.

Such information is collected and evaluated. It is then made available to a field representative who can inspect the facility to determine that the information presented is accurate and that the facility is in compliance with the agency's requirements. Field representatives are generally hired by the agency to visit the manufacturers' facilities. The field representative may be a Rabbi (generally an independent contractor) who inspects facilities on behalf of a certification agency. This person is often referred to as a Mashgiach or the plural Mashgichim.

Ingredients must, of course, be approved as part of the approval process for a product. Such approval may be based on any of several factors. The most common factor is a kosher certificate provided by the supplier of the ingredient. The kosher certificate is issued by a certification agency for the ingredient. Importantly, it often happens that the certification agency certifying the kosher status of the ingredient is not the same as the certification agency certifying the kosher status of the product. Each certification agency will evaluate the ingredient based on its kosher certification and its suitability to that facility.

Other ways of evaluating an ingredient may include general knowledge that the type of ingredient does not pose a kosher problem. Depending on the certification agency, an ingredient may be evaluated based on knowledge from the package labeling or from other sources, without requiring a kosher certificate for the ingredient.

After a favorable evaluation the product will be certified to be kosher. The certification agency provides a letter (referred to herein as a kosher certificate) attesting to the product's kosher status. The certification agency may also give permission to the manufacturer to print the agency's symbol on the label.

Throughout the period of certification the certification agency must, of course, be kept informed about any changes or additions to ingredients, formulas and production methods that affect the certified products. In addition, it is routine to have requests to add new certified products from time to time.

The manufacturer and the certification agency will typically have a relationship that lasts a year and that is routinely renewed. Each kosher certificate has an expiration date, and issuance of a new kosher certificate to replace the expired one is tied to continued inspections and continued provision of information about the product or products by the manufacturer to the certification agency. A kosher certificate will thus typically have an expiration a year after it has been issued.

Consider, then, what happens if a kosher certification for a product is based, in part, on a kosher certificate (for an ingredient) issued by a certification agency that is not the same as the agency certifying the product. As a general matter it may be expected that the kosher certificate for the ingredient will have an expiration date that is not the same as the expiration date of the kosher certificate for the product. Thus, it is necessary to obtain updated certificates for the ingredients as they expire.

It will also be appreciated that in food manufacturing processes, there can be many companies involved in many different ways. One company may manufacture nothing at all, simply purchasing a product from someone else and affixing its own label on the product. Another may outsource the manufacturing of its product by essentially renting equipment owned by another company. Still other companies manufacture products that are to be labeled by others.

In addition, there are specialized parts of the food service industry, such as restaurants, caterers, hotels and bakeries. Such specialized businesses are typically kosher-certified in their entirety, rather than for specific products.

A particular certification agency may find itself certifying at any location along these chains of production. This may mean that the certification agency must certify other parts, or arrange for certification of other parts. For example, if a certification agency is certifying someone who does not manufacture, but who instead purchases products and relabels them, the agency must necessarily enter into some arrangement with the actual manufacturer to ensure that the product is kosher. As another example, if a certification agency certifies products that are sold to others and relabeled by them, the agency must necessarily retain control of its symbol for those who relabel the product.

It will thus be appreciated that several categories of entities interact with each other in connection with kosher certification. There are the certification agencies, the field representatives, and the customers, which in this context include manufacturers, ingredient suppliers, and others in the chain of production.

Many prior-art systems for certifying products as kosher, and for accomplishing the other tasks discussed above, have been in use for a very long time. Such systems are, however, very cumbersome. They rely upon passing physical items such as kosher certificates from one entity to another. A report from a field representative typically must be filed on paper. A request for an approval for an ingredient change may well take a long time to be processed. Obtaining kosher certification for a new product may also take a long time. The processing of paperwork is expensive. It is not easy to generate all of the reports that one or another of the entities mentioned above might wish to be able to generate.

The process of being certified kosher is, at the present time, a paper-intensive process. One particular paper-intensive part of this process arises when a customer submits a request to use an ingredient in a kosher facility or in a kosher product. FIG. 1 shows a prior-art sequence of data flows relating to an add, change, or delete of an ingredient. The certified company 10 must get a kosher letter from its vendor (also a supplier or distributor) 12. The kosher letter typically contains:
the name of the certifying agency
the name of the company being certified
the name of the product it attests to being certified
the “kosher evaluation” such as pareve, dairy, Passover, etc.
the expiration date and issue date of the letter
signature
other supporting information.

It should be appreciated that in some cases the supplier of an ingredient to a manufacturer may in turn be distributing an ingredient from its own supplier. Thus, in this context, when we refer to asking a supplier or vendor to provide a unique identifier or a kosher certificate, this may in some contexts mean asking the distributor who may in turn query the distributor's supplier.

The certified company 10 typically needs to send the certifying agency 11 a form requesting to add or modify or delete the ingredient This typically requires the company 10 to attach the kosher letter from the vendor 12 attesting to the certification of the ingredient.

As will be appreciated, this paperflow is cumbersome. It is also a big challenge to keep the kosher letters updated as they usually expire yearly. For example, a company with 5000 ingredients in its inventory and an average of a couple of hundred new ingredients per year not only has the challenge of obtaining certificates for the new ingredients but also must attend to the annual expirations of the thousands of other ingredients in the inventory.

As is described in the above-mentioned PCT publication WO 02/080074, it has been suggested to establish a system in which a unique identifier is given to a product for which there is a kosher letter. The process of certifying the kosher status of a product containing ingredients is thus made less tedious because many or all of the ingredients might have such unique identifiers. With a list of such unique identifiers for ingredients in a proposed product, a manufacturer would be able to provide to its certification agency the list, and the certification agency could use the unique identifiers to “call up” the kosher letters (or information about the kosher letters) from one or more databases. This would remove some of the traditional prior-art inefficiencies. Such an approach does not, however, directly address a problem which is that many ingredients and manufactured products that have kosher letters may not have unique identifiers of the type contemplated by this system.

### SUMMARY OF THE INVENTION

A first entity, receives from customer or form an agency on behalf of a customer an ingredient list comprising ingredients and contact information for a supplier of each ingredient. For each ingredient needing a certificate, the first entity contacts each respective supplier requesting a copy of a kosher letter for the ingredient. The kosher letter is received and one or more associated unique identifiers are assigned and communicated to the supplier and/or any other subscribed party such as the customer(s) and/or the agency or agencies certifying the manufactured product made with this ingredient list, as applicable. This eliminates the need for the supplier and/or the customer to have to take further action with respect to the kosher letters. A kosher certification agency is able to use the unique identifiers to obtain information for use in deciding whether to grant a kosher certification to the product of the ingredient list. The first entity notes when kosher letters are going to expire and requests new kosher letters directly from the associated suppliers, eliminating the need for the customer or agency to perform that action.

### DESCRIPTION OF THE DRAWINGS

FIG. 1 shows a prior-art sequence of data flows relating to an add, change, or delete of an ingredient.

FIG. 2 shows a sequence of data flows in a system according to the invention.

FIG. 3 describes another sequence of events according to the invention.

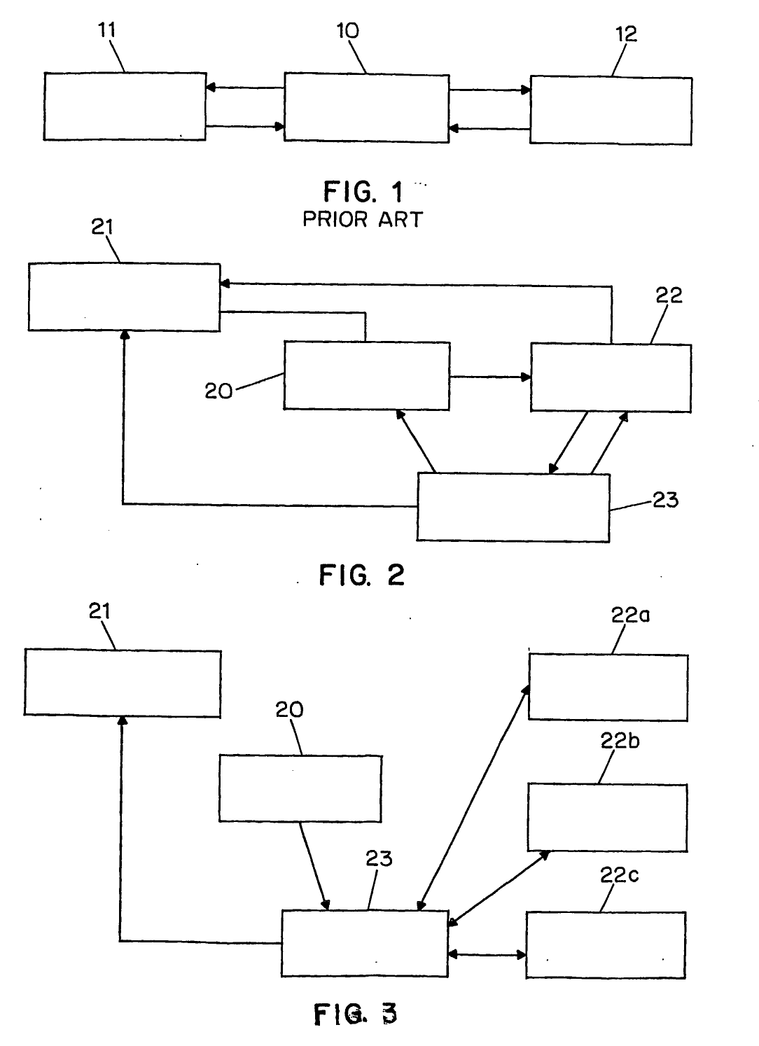

### DETAILED DESCRIPTION

FIG. 2 shows a sequence of data flows in a system according to the invention. A customer 20 of a certification agency 21 notifies a vendor 22 of its desire to stop receiving paper certificates for the products it buys from vendor 22. Instead, the customer 20 would prefer henceforth to receive only unique identifiers for the kosher letters associated with the products from vendor 22. The company 20 directs the vendor 22 to a service provider 23, typically a web site.

The vendor 22 then goes to the service provider 23.

If the vendor 22 has no previous relationship with the service provider 23, then the vendor 22 would sign up to become a member and would obtain a user name and password. The vendor 22 provides basic information such as the company name of the vendor 22, address, telephone, fax, email address, and the certification agency or agencies with which the vendor 22 has a relationship.

The vendor 22 logs in to the service provider 23.

The vendor 22 enters a name of an ingredient for which it wishes to receive a unique identifier of the type described above. The vendor 22 may also enter information such as the certification agency that granted the kosher letter for the ingredient, as well as the kosher evaluation status, restrictions if any, and expiration date.

Next the vendor 22 provides the kosher letter to the service provider 23. Most efficiently this is done by scanning the kosher letter into an appropriate image file (e.g. TIF or PDF) and the file is uploaded to the web site. Less preferably, the vendor 22 selects a “fax” option which results in a cover sheet being printed out. The cover sheet is used to fax the kosher letter to the service provider 23.

As an alternative to the vendor entering detailed information, the service provider may enter such information into its database based upon the image of the kosher letter.

A next step is that the service provider 23 reviews the uploaded or faxed image, comparing it with the information entered by the vendor 22. This may be visual or via OCR, for example. In the event of a successful comparison, the service provider 23 gives a unique identifier to the ingredient. Alternatively the service provider may not need to make such a comparison if the service provider has already entered such information. It will be appreciated that as a general rule, information on the certificate itself should override any information previously manually entered.

In addition, the service provider may choose to check for possible duplicates among items listed in kosher letters, so as to minimize the possibility of duplicate unique identifiers being assigned for a particular items in a single kosher letter which may have been submitted by more than one supplier.

Once the unique identifier is assigned, several remaining communications can take place in very efficient fashion. The service provider 23 may provide the unique identifier to the vendor 22. In addition the service provider 23 may provide the unique identifier to the company 20. In addition the service provider 23 may provide the unique identifier to the certification agency. Alternatively the vendor 22 may provide the unique identifier to the company 20.

The company 20 provides the unique identifier to the certification agency 21, preferably via web communication or email. The certification agency 21 may then “subscribe” to the unique identifier to receive the supporting information and the image file. Any change in the status of the kosher letter can be posted to the unique identifier and thus the certification agency 21 can learn of such a change automatically.

It will be appreciated that from the point of view of a vendor 22, an advantage is that the unique identifier can be reused for other customers 20. If the vendor 22 provides a particular ingredient to each of several manufacturers 20, the single unique identifier may be provided to all of the manufacturers 20 and this helps each manufacturer 20 to streamline communications to its respective certification agency 21.

The service provider 23 can keep track of expiration dates for kosher letters. When a kosher letter is about to expire, the service provider 23 can contact the associated vendor 22 to ask for a new kosher letter. The vendor 22 goes to its respective certification agency (which in the general case may not be the same certification agency 21 that serves a particular manufacturer 20) and obtains a new kosher letter. The new kosher letter is provided to the service provider 23 who then updates the data relating to the unique identifier (e.g. new expiration date) and the new image file is made available to certification agencies 21.

Preferably and efficiently, the service provider will make such requests for new kosher letters in batches, for example a batch of kosher letters that are expected to expire between one and two months in the future or in the past.

FIG. 3 describes another sequence of events according to the invention. In this approach, a manufacturer 20 has a certification agency 21. The manufacturer 20 provides an ingredient list to the service provider 23 either directly or via the certification agency. The ingredient list lists ingredients and, for each ingredient needing a certificate, the identity of the vendor (e.g. 22a, 22b, 22c) providing the ingredient, and for each vendor contact information is provided such as a fax number or more preferably an email address; In some cases it may develop that a particular vendor supplies more than one ingredient on the list, in which case a single piece of contact information suffices for that vendor and all of that vendor's ingredients.

Next, the service provider 23 contacts each of the vendors 22a, 22b, 22c. Each vendor follows the procedure described above, to obtain a unique identifier for its ingredient and for the kosher letter associated with that ingredient. The unique identifiers are provided to the certification agency 21, either directly or through the customer (manufacturer) 20. The certification agency can very efficiently obtain and review kosher letter information for the ingredients on the list, and thus can arrive promptly at a decision whether to provide the requested kosher certification for the product associated with the ingredient list.

It will now be appreciated that this system offers some advantages to vendors that supply ingredients to more than one customer, as they will only have to deal with kosher certificates and unique identifiers once. This system also offers some advantages to the service provider because in some cases it may have a ingredient used by more than one customer, and a single query to the vendor for that ingredient will suffice. Stated differently, each customer need not hesitate to ask its vendors for cooperation in this process because other customers will very often also have been asking for such cooperation. It also provides benefit to the certification agency by eliminating its needs to deal with this paper and by being able to serve its customers better.

It will be appreciated that in some cases the vendor may already have a unique identifier for its ingredient, in which case it does not need to follow the procedure described above for obtaining a unique identifier. Instead it provides the unique identifier to the service provider 23 in response to the query. Indeed in some cases the manufacturer 20 may be in possession of unique identifiers for one or more of the ingredients on the ingredient list, in which case the list provided to the service provider 23 will list the unique identifiers where they are already known.

As a general matter, then, the system according to the invention has applicability to many applications that are somewhat similar. Those skilled in the art will have no difficulty devising myriad obvious variations and improvements, all of which are intended to fall within the scope of the claims which follow.

1. A method for use in connection with a first entity, first and second customers of the first entity, and a multiplicity of suppliers of the customers, the method comprising the steps of:
by the first entity, receiving from the first customer of the first entity a first ingredient list, the first ingredient list comprising ingredients, at least one of which requires a kosher certificate, and for each ingredient requiring a kosher certificate, contact information for a respective supplier of the ingredient;
by the first entity, contacting the respective supplier for each ingredient of the first ingredient list requiring a kosher certificate and requesting a copy of a kosher letter for the ingredient;
for each ingredient of the first ingredient list requiring a kosher certificate, receiving by the first entity the copy of the requested kosher letter;
for each ingredient in the first ingredient list requiring a kosher certificate, assigning by the first entity a unique identifier associated with said ingredient;
for each ingredient in the first ingredient list requiring a kosher certificate, communicating the unique identifier to the respective supplier;
by the first entity, receiving from the second customer of the first entity a second ingredient list, the second ingredient list comprising ingredients at least one of which requires a kosher certificate, and for each ingredient requiring a kosher certificate, contact information for a respective supplier of the ingredient;
by the first entity, contacting the respective supplier for each ingredient of the second ingredient list requiring a kosher certificate and requesting a copy of a kosher letter for the ingredient;
for each ingredient of the second ingredient list requiring a kosher certificate, receiving by the first entity the copy of the requested kosher letter;
for each ingredient in the second ingredient list requiring a kosher certificate, assigning by the first entity a unique identifier associated with said ingredient;
for each ingredient in the second ingredient list requiring a kosher certificate, communicating the unique identifier to the respective supplier.

2. The method of claim 1 comprising the additional step of:
for each ingredient in the first ingredient list requiring a kosher certificate, communicating the unique identifier back to the first customer.

3. The method of claim 1 comprising the additional step of:
for each ingredient in the first ingredient list requiring a kosher certificate, communicating the unique identifier back to a certification agency.

4. The method of claim 1 comprising the additional step of:
for each ingredient in the first ingredient list requiring a kosher certificate, communicating the unique identifier back to the first customer and to a kosher certification agency.

5. The method of claim 1 wherein the contact information comprises an email address.

6. The method of claim 1 wherein the contact information comprises a fax number.

7. The method of claim 1 wherein the first entity is not a kosher certification agency.

8. The method of claim 1 in which each kosher letter has an associated expiration date, the method further comprising the steps of:
identifying, by the first entity, kosher letters that will expire or have expired;
for each identified kosher letter, contacting the supplier associated therewith and asking for a new kosher letter.

9. The method of claim 8 further comprising the step of:
for at least one identified kosher letter, receiving the new kosher letter.

10. The method of claim 9 further comprising the step of:
communicating the new kosher letter to the first customer.

11. The method of claim 9 further comprising the step of:
communicating the new kosher letter to a certification agency.

12. The method of claim 9 further comprising the steps of:
communicating the new kosher letter to the first customer; and
communicating the new kosher letter to a certification agency.

13. A method for use in connection with a first entity, first and second customers of the first entity, and a multiplicity of suppliers of the customers, the method comprising the steps of:
by the first entity, receiving from the first customer of the first entity a first ingredient list, the first ingredient list comprising ingredients, and for each ingredient, either contact information for a respective supplier of the ingredient, or a unique identifier associated with the ingredient;
by the first entity, contacting the respective supplier for each ingredient of the first ingredient list for which no unique identifier was supplied, and requesting a copy of a kosher letter for the ingredient;
for each ingredient of the first ingredient list for which no unique identifier was supplied, receiving by the first entity the copy of the requested kosher letter;
for each ingredient in the first ingredient list for which no unique identifier was supplied, assigning by the first entity a unique identifier associated with said ingredient;
for each ingredient in the first ingredient list for which no unique identifier was supplied, communicating the unique identifier to the respective supplier;
by the first entity, receiving from the second customer of the first entity a second ingredient list, the second ingredient list comprising ingredients, and for each ingredient, either contact information for a respective supplier of the ingredient, or a unique identifier associated with the ingredient;
by the first entity, contacting the respective supplier for each ingredient of the second ingredient list for which no unique identifier was supplied, and requesting a copy of a kosher letter for the ingredient;
for each ingredient of the second ingredient list for which no unique identifier was supplied, receiving by the first entity the copy of the requested kosher letter;
for each ingredient in the second ingredient list for which no unique identifier was supplied, assigning by the first entity a unique identifier associated with said ingredient;
for each ingredient in the second ingredient list for which no unique identifier was supplied, communicating the unique identifier to the respective supplier.

14. The method of claim 13 comprising the additional step of:
for each ingredient in the first ingredient list requiring a kosher certificate, communicating the unique identifier back to the first customer.

15. The method of claim 13 comprising the additional step of:
for each ingredient in the first ingredient list requiring a kosher certificate, communicating the unique identifier back to a certification agency.

16. The method of claim 13 comprising the additional step of:
for each ingredient in the first ingredient list requiring a kosher certificate, communicating the unique identifier back to the first customer and to a kosher certification agency.

17. The method of claim 13 wherein the contact information comprises an email address.

18. The method of claim 13 wherein the contact information comprises a fax number.

19. The method of claim 13 wherein the first entity is not a kosher certification agency.

20. The method of claim 13 in which each kosher letter has an associated expiration date, the method further comprising the steps of:
identifying, by the first entity, kosher letters that will expire or have expired;
for each identified kosher letter, contacting the supplier associated therewith and asking for a new kosher letter.

21. The method of claim 20 further comprising the step of:
for at least one identified kosher letter, receiving the new kosher letter.

22. The method of claim 21 further comprising the step of:
communicating the new kosher letter to the first customer.

23. The method of claim 21 further comprising the step of:
communicating the new kosher letter to a certification agency.

24. The method of claim 21 further comprising the steps of:
communicating the new kosher letter to the first customer; and
communicating the new kosher letter to a certification agency.

25. A method for use in connection with a first entity and myriad ingredients, each ingredient supplied by a respective supplier, each ingredient having an associated kosher letter having a respective expiration date, each ingredient having an associated unique identifier assigned by the first entity, the method comprising the steps of:
identifying, by the first entity, kosher letters that will expire or have expired;
for each identified kosher letter, contacting the supplier associated therewith and asking for a new kosher letter.

26. The method of claim 25 further comprising the step of:
for at least one of the identified kosher letters, receiving the new kosher letter.

27. The method of claim 26 further comprising the step of:
communicating the new kosher letter to a customer.

28. The method of claim 26 further comprising the step of:
communicating the new kosher letter to a certification agency.

29. The method of claim 26 further comprising the steps of:
communicating the new kosher letter to a customer; and
communicating the new kosher letter to a certification agency.

30. A method for use in connection with a first entity, first and second customers of the first entity, and a multiplicity of suppliers of the customers, the method comprising the steps of:
by the first entity, receiving from the first customer of the first entity a first ingredient to be added to a first ingredient list, the first ingredient list comprising ingredients, the first ingredient requiring a kosher certificate, and for the first ingredient, contact information for a respective supplier of the first ingredient;
by the first entity, contacting the respective supplier of the first ingredient and requesting a copy of a kosher letter for the first ingredient;
for the first ingredient, receiving by the first entity the copy of the requested kosher letter;
for the first ingredient, assigning by the first entity an associated unique identifier;
for the first ingredient communicating the unique identifier to the respective supplier;
by the first entity, receiving from the second customer of the first entity a second ingredient to be added to a second ingredient list, the second ingredient list comprising ingredients, the second ingredient requiring a kosher certificate, and for the second ingredient, contact information for a respective supplier of the second ingredient;
by the first entity, contacting the respective supplier of the second ingredient and requesting a copy of a kosher letter for the second ingredient;
for the second ingredient, receiving by the first entity the copy of the requested kosher letter;
for the second ingredient, assigning by the first entity an associated unique identifier; and
for the second ingredient communicating the unique identifier to the respective supplier.

31. The method of claim 30 comprising the additional step of:
for each ingredient in the first ingredient list requiring a kosher certificate, communicating the unique identifier back to the first customer.

32. The method of claim 30 comprising the additional step of:
for each ingredient in the first ingredient list requiring a kosher certificate, communicating the unique identifier back to a certification agency.

33. The method of claim 30 comprising the additional step of:
for each ingredient in the first ingredient list requiring a kosher certificate, communicating the unique identifier back to the first customer and to a kosher certification agency.

34. The method of claim 30 wherein the contact information comprises an email address.

35. The method of claim 30 wherein the contact information comprises a fax number.

36. The method of claim 30 wherein the first entity is not a kosher certification agency.

37. The method of claim 30 in which each kosher letter has an associated expiration date, the method further comprising the steps of:
identifying, by the first entity, kosher letters that will expire or have expired;
for each identified kosher letter, contacting the supplier associated therewith and asking for a new kosher letter.

38. The method of claim 37 further comprising the step of:
for at least one identified kosher letter, receiving the new kosher letter.

39. The method of claim 38 further comprising the step of:
communicating the new kosher letter to the first customer.

40. The method of claim 38 further comprising the step of:
communicating the new kosher letter to a certification agency.

41. The method of claim 38 further comprising the steps of:
communicating the new kosher letter to the first customer; and
communicating the new kosher letter to a certification agency.

42. A method for use in connection with a first entity, first and second customers of the first entity, and a multiplicity of suppliers of the customers, the method comprising the steps of:
by the first entity, receiving from the first customer of the first entity a first ingredient to be added to a first ingredient list, the first ingredient list comprising ingredients, the first ingredient requiring a kosher certificate, and for the first ingredient, contact information for a respective supplier of the first ingredient;
by the first entity, contacting the respective supplier of the first ingredient and requesting a unique identifier associated with the first ingredient;
for the first ingredient, receiving by the first entity the unique identifier associated with the first ingredient;
for the first ingredient communicating the unique identifier to the respective supplier;
by the first entity, receiving from the second customer of the first entity a second ingredient to be added to a second ingredient list, the second ingredient list comprising ingredients, the second ingredients requiring a kosher certificate, and for the second ingredient, contact information for a respective supplier of the second ingredient;
by the first entity, contacting the respective supplier of the second ingredient and requesting a unique identifier associated withe the second ingredient; and
for the second ingredient, receiving by the first entity the unique identifier associated with the second ingredient.

43. The method of claim 42 comprising the additional step of:
for each ingredient in the first ingredient list requiring a kosher certificate, communicating the unique identifier back to the first customer.

44. The method of claim 42 comprising the additional step of:
for each ingredient in the first ingredient list requiring a kosher certificate, communicating the unique identifier back to a certification agency.

45. The method of claim 42 comprising the additional step of:
for each ingredient in the first ingredient list requiring a kosher certificate, communicating the unique identifier back to the first customer and to a kosher certification agency.

46. The method of claim 42 wherein the contact information comprises an email address.

47. The method of claim 42 wherein the contact information comprises a fax number.

48. The method of claim 42 wherein the first entity is not a kosher certification agency.

49. The method of claim 42 in which each kosher letter has an associated expiration date, the method further comprising the steps of:
identifying, by the first entity, kosher letters that will expire or have expired;
for each identified kosher letter, contacting the supplier associated therewith and asking for a new kosher letter.

50. The method of claim 49 further comprising the step of:
for at least one identified kosher letter, receiving the new kosher letter.

51. The method of claim 49 further comprising the step of:
communicating the new kosher letter to the first customer.

52. The method of claim 49 further comprising the step of:
communicating the new kosher letter to a certification agency.

53. The method of claim 49 further comprising the steps of:
communicating the new kosher letter to the first customer; and
communicating the new kosher letter to a certification agency.

54. A method for use in connection with a first entity, first and second customers of the first entity, and a multiplicity of suppliers of the customers, the method comprising the steps of:
by the first entity, receiving a first ingredient list relating to a first customer of the first entity, the first ingredient list comprising ingredients, at least one of which requires a kosher certificate, and for each ingredient requiring a kosher certificate, contact information for a respective supplier of the ingredient;
by the first entity, contacting the respective supplier for each ingredient of the first ingredient list requiring a kosher certificate and requesting a copy of a kosher letter for the ingredient;
for each ingredient of the first ingredient list requiring a kosher certificate, receiving by the first entity the copy of the requested kosher letter;
for each ingredient in the first ingredient list requiring a kosher certificate, assigning by the first entity an associated unique identifier;
for each ingredient in the first ingredient list requiring a kosher certificate, commnunicating the unique identifier to the respective supplier;
by the first entity, receiving a second ingredient list relating to a second customer of the first entity, the second ingredient list comprising ingredients at least one of which requires a kosher certificate, and for each ingredient requiring a kosher certificate, contact information for a respective supplier of the ingredient;
by the first entity, contacting the respective supplier for each ingredient of the second ingredient list requiring a kosher certificate and requesting a copy of a kosher letter for the ingredient;
for each ingredient of the second ingredient list requiring a kosher certificate, receiving by the first entity the copy of the requested kosher letter;
for each ingredient in the second ingredient list requiring a kosher certificate, assigning by the first entity an associated unique identifier;
for each ingredient in the second ingredient list requiring a kosher certificate, communicating the unique identifier to the respective supplier.

55. The method of claim 54 comprising the additional step of:
for each ingredient in the first ingredient list requiring a kosher certificate, communicating the unique identifier back to the first customer.

56. The method of claim 54 comprising the additional step of:
for each ingredient in the first ingredient list requiring a kosher certificate, communicating the unique identifier back to a certification agency.

57. The method of claim 54 comprising the additional step of:
for each ingredient in the first ingredient list requiring a kosher certificate, communicating the unique identifier back to the first customer and to a kosher certification agency.

58. The method of claim 54 wherein the contact information comprises an email address.

59. The method of claim 54 wherein the contact information comprises a fax number.

60. The method of claim 54 wherein the first entity is not a kosher certification agency

61. The method of claim 54 in which each kosher letter has an associated expiration date, the method further comprising the steps of
identifying, by the first entity, kosher letters that will expire or have expired;
for each identified kosher letter, contacting the supplier associated therewith and asking for a new kosher letter.

62. The method of claim 61 further comprising the step of:
for at least one identified kosher letter, receiving the new kosher letter.

63. The method of claim 62 further comprising the step of communicating the new kosher letter to the first customer.

64. The method of claim 62 further comprising the step of:
communicating the new kosher letter to a certification agency.

65. The method of claim 62 further comprising the steps of communicating the new kosher letter to the first customer; and
communicating the new kosher letter to a certification agency.

66. A method for use in connection with a first entity, first and second customers of the first entity, and a multiplicity of suppliers of the customers, the method comprising the steps of:
by the first entity, receiving a first ingredient to be added to a first ingredient list relating to the first customer of the first entity, the first ingredient list comprising ingredients, the first ingredient requiring a kosher certificate, and for the first ingredient, contact information for a respective supplier of the first ingredient;
by the first entity, contacting the respective supplier of the first ingredient and requesting a copy of a kosher letter for the first ingredient;
for the first ingredient, receiving by the first entity the copy of the requested kosher letter;
for the first ingredient, assigning by the first entity an associated unique identifier;
for the first ingredient communicating the unique identifier to the respective supplier;
by the first entity, receiving a second ingredient to be added to a second ingredient list relating to the second customer of the first entity, the second ingredient list comprising ingredients, the second ingredient requiring a kosher certificate, and for the second ingredient, contact information for a respective supplier of the second ingredient;
by the first entity, contacting the respective supplier of the second ingredient and requesting a copy of a kosher letter for the second ingredient;
for the second ingredient, receiving by the first entity the copy of the requested kosher letter;
for the second ingredient, assigning by the first entity an associated unique identifier; and
for the second ingredient communicating the unique identifier to the respective supplier.

67. The method of claim 66 comprising the additional step of:
for each ingredient in the first ingredient list requiring a kosher certificate, communicating the unique identifier back to the first customer.

68. The method of claim 66 comprising the additional step of:
for each ingredient in the first ingredient list requiring a kosher certificate, communicating the unique identifier back to a certification agency.

69. The method of claim 66 comprising the additional step of:
for each ingredient in the first ingredient list requiring a kosher certificate, communicating the unique identifier back to the first customer and to a kosher certification agency.

70. The method of claim 66 wherein the contact information comprises an email address.

71. The method of claim 66 wherein the contact information comprises a fax number.

72. The method of claim 66 wherein the first entity is not a kosher certification agency.

73. The method of claim 66 in which each kosher letter has an associated expiration date, the method further comprising the steps of:
identifying, by the first entity, kosher letters that will expire or have expired;
for each identified kosher letter, contacting the supplier associated therewith and asking for a new kosher letter.

74. The method of claim 73 further comprising the step of:
for at least one identified kosher letter, receiving the new kosher letter.

75. The method of claim 74 further comprising the step of:
communicating the new kosher letter to the first customer.

76. The method of claim 74 further comprising the step of:
communicating the new kosher letter to a certification agency.

77. The method of claim 74 further comprising the steps of:
communicating the new kosher letter to the first customer; and
communicating the new kosher letter to a certification agency.

78. A method for use in connection with a first entity, first and second customers of the first entity, and a multiplicity of suppliers of the customers, the method comprising the steps of:
by the first entity, receiving from the first customer of the first entity a first ingredient list, the first ingredient list comprising ingredients, at least one of which requires a kosher certificate, and for each ingredient requiring a kosher certificate, either contact information for a respective supplier of the ingredient or a unique identifier associated with the ingredient;
by the first entity, contacting the respective supplier for each ingredient of the first ingredient list requiring a kosher certificate for which contact information is provided, and requesting a unique identifier associated with the ingredient or a copy of a kosher letter for the ingredient;
for each ingredient of the first ingredient list requiring a kosher certificate for which contact information is provided, in the event that a copy of the requested kosher letter is received by the first entity, assigning by the first entity a unique identifier associated with said ingredient, and communicating the unique identifier to the respective supplier;
by the first entity, receiving from the second customer of the first entity a second ingredient list, the second ingredient list comprising ingredients at least one of which requires a kosher certificate, and for each ingredient requiring a kosher certificate, contact information for a respective supplier of the ingredient or a unique identifier associated with the ingredient;
by the first entity, contacting the respective supplier for each ingredient of the second ingredient list requiring a kosher certificate and requesting either a copy of a kosher letter for the ingredient or a unique identifier for the ingredient;
for each ingredient of the second ingredient list requiring a kosher certificate for which contact information is provided, in the event that a unique identifier is received by the first entity, storing, by the first entity, the unique identifier.

79. The method of claim 78 comprising the additional step of:
for each ingredient in the first ingredient list requiring a kosher certificate, communicating the unique identifier back to the first customer.

80. The method of claim 78 comprising the additional step of:
for each ingredient in the first ingredient list requiring a kosher certificate, communicating the unique identifier back to a certification agency.

81. The method of claim 78 comprising the additional step of:
for each ingredient in the first ingredient list requiring a kosher certificate, communicating the unique identifier back to the first customer and to a kosher certification agency.

82. The method of claim 78 wherein the contact information comprises an email address.

83. The method of claim 78 wherein the contact information comprises a fax number.

84. The method of claim 78 wherein the first entity is not a kosher certification agency.

85. The method of claim 78 in which each kosher letter has an associated expiration date, the method further comprising the steps of:
identifying, by the first entity, kosher letters that will expire or have expired;
for each identified kosher letter, contacting the supplier associated therewith and asking for a new kosher letter.

86. The method of claim 85 further comprising the step of:
for at least one identified kosher letter, receiving the new kosher letter.

87. The method of claim 86 further comprising the step of:
communicating the new kosher letter to the first customer.

88. The method of claim 86 further comprising the step of:
communicating the new kosher letter to a certification agency.

89. The method of claim 86 further comprising the steps of:
communicating the new kosher letter to the first customer; and
communicating the new kosher letter to a certification agency.
